(19) United States
(12) Patent Application Publication
(10) Pub. No.: US 2019/0009809 A1
(43) Pub. Date: Jan. 10, 2019

(54) Transportation Brackets

(71) Applicant: James Jacob Newenhouse, West Fargo, ND (US)

(72) Inventor: James Jacob Newenhouse, West Fargo, ND (US)

(21) Appl. No.: 16/025,433

(22) Filed: Jul. 2, 2018

Related U.S. Application Data
(60) Provisional application No. 62/528,857, filed on Jul. 5, 2017.

(51) Int. Cl. B62B 5/00; E04F 21/00

(52) U.S. Cl. CPC B62B 5/0086; E04F 21/0023; B62B 2202/00; B62B 2301/252; B62B 2205/30; B62B 2301/04; B62B 2203/00

(57) ABSTRACT

A transport bracket disclosed herein includes a support structure and at least one vertical beam which extend sin a substantially vertical direction upward from a side of the support structure. Where the bracket is configured for the transport of a door or similar objects, two beams are present with one opposite the other. A mounting plate extending horizontally from each beam. Each mounting plate defines an opening for receipt of a vertical adjustment shaft which extending through the opening and is threadingly engaged thereto. The vertical adjustment shaft has a top located vertically above the mounting plate, and a bottom located vertically below the mounting plate. A handle is operatively engaged to the top and a wheel assembly is engaged to the bottom. Rotation of the handle changes the proximity of the wheel assembly to the mounting plate. The wheel assembly has an axle extending from the vertical adjustment shaft, and at least one wheel rotatably engaged about the axle.

### CROSS-REFERENCE TO RELATED APPLICATIONS

This application is a Utility filing claiming priority to Provisional Patent Application No. 62/528,857, filed on Jul. 5, 2017 and entitled “Single- and Dual-Wheeled Transportation Device”, the entire contents of which are incorporated herein by reference.

### FIELD OF INVENTION

This disclosure pertains generally to the field of transportation of items, specifically to the application of transporting furniture, doors, materials, and other items, and more specifically to a door transportation and installation device.

### BACKGROUND

The current state of the art related to the transportation of large items such as doors, and particularly swing doors of the type found in the vast majority of homes and businesses is dominated by apparatuses which rely on individual and multiple wheels, rollers, sliders, or similar with a frame to hold the rolling devices together. Bracing handles, clamps and similar mechanisms may be used as a method of which to control the entire item during transport. There are devices which rely on the use of a clamp or similar device to temporarily secure a wheel, roller, etc. to the item to be transported. The current state of the art, however does not provide for a device which can be independently adjusted for height, is of sufficiently low profile to transport the item and be readily removed once the item is properly positioned and contains a single or dual wheel, roller, or similar.

Some known transport devices in this field of technology include:

U.S. Pat. No. 6,955,367 by Simonsen et al. describes a picnic table mover with one wheel and a post fastened to the table. The invention can rotate into an engaged position for transportation, or a retracted position for stationary use. The claims detail specifics of using two total wheels on a single picnic table. The invention is fastened to the picnic table and is not easily removed; it also does not have a height adjustment, and is not low profile. This would make a challenge to use the present disclosure on items other than what it was specifically designed for, or as a portable device to use on multiple items.

U.S. Pat. No. 6,450,515 by Guth et al. teaches of a one-wheel clip on device for pallets or other structures with runners. This invention has a non-articulating single wheel and a metal clip which attaches to a wooden pallet. There is no height adjustment, no mechanism for easy maneuverability, it is not low profile and is specifically designed for pallets.

Another device is the Door-Set™ available at finefinishcarpentry.com. This device has a single frame which attaches to a door using a thumb screw and individually height adjustable wheels on a large dolly like structure.

All known transport devices do not provide for a mechanism that allows for the transport of large items such as doors and which allows the item being transported to be accurately positioned and repositioned as desired, and which has a sufficiently low profile so as to be readily removed from the item when the transport device is no longer required. The embodiments described in this disclosure provide for such a transportation device.

Embodiments described herein provide a door transportation device, hereinafter a transport bracket, which can be used to transport the door, and install the door by being adjustable for height, level, plumb, and the physical position of the door; and which can be slid from under the door once the door is secured into its frame.

### SUMMARY

It is one objective of the present disclosure to replace furniture, door, or other similar component movers which rely on multiple wheels, rollers, or similar with a transport bracket a single or dual wheel roller, of the embodiments described herein.

It is another objective of the present disclosure that the transported object is held above the wheel(s) of the transport bracket can be adjusted by means of a manual knob, screw, or similar device or mechanism.

It is another objective of the present disclosure that the height adjustment is actuated by a rotating knob, screw or similar device or mechanism which is connected directly to an articulating wheel so that the wheel, threaded rod, and knob handle or similar device is in-line. The height adjustment allows for the object being transported to be adjusted for height on each individual wheel which, intern allows for leveling in multiple directions.

It is another objective of the present disclosure to provide for a transport bracket that is easily installed and removed from the transported object by means of an adjustment, friction fit, tie strap, toggle clamp, or similar device which will not damage the transported object.

It is another objective of the present disclosure that the transport bracket is of low profile so that it easily fits underneath the transported object and is also easily removed therefrom once the object is positioned or mounted in a desired location.

It is another objective of the present disclosure that the transport bracket can be attached to a pre-hung or slab door and used for both transportation and installation.

It is yet another objective of the present disclosure that the transport bracket has a long and short side which allows for clearance of the device when installing a door near an adjacent wall.

Further objectives and advantages of the embodiments described herein will become apparent from a consideration of the drawings and ensuing description.

### DESCRIPTION OF THE DRAWINGS

FIG. 1a is a perspective view of an object with an embodiment of the present transport bracket configured for engagement to the corners of the object removeably engaged to two corners of the object.

FIG. 1b is a close-up, perspective view of one of the transport brackets shown in FIG. 1a.

FIG. 1c is a top down view of the transport bracket shown in FIG. 1a-b.

FIG. 2 is a perspective view of an embodiment of the transport bracket having with a single adjustable wheel assembly and configured for transport of an object such as a door.

FIG. 3 is a perspective view of an alternative embodiment of the single wheel the door transport bracket shown in FIG. 2.

FIG. 4 is a perspective view of an embodiment of the door transport bracket with two adjustable wheel assemblies.

FIG. 5 is a perspective view of a door being supported at its base and ready for transport via a pair of door transport brackets of the type shown in FIG. 4.

FIG. 6 is a perspective view of a door and a pair of door transport brackets of the type shown in FIGS. 4-5 and depicting an exemplary manner in which the brackets are positioned at the base of the door when the door is on its side or in a horizontally oriented position.

FIG. 7 is a perspective view of the assembly of door and brackets shown in FIG. 6, but with the door now in an upright or vertically oriented position with the door transport brackets ready for transport of the door.

FIG. 8 is a perspective view of the assembly of door and transport brackets shown in FIGS. 5-7, wherein the assembly has been transported, and oriented into position such that the door is ready for installation into the rough opening of a wall.

FIG. 9 is a perspective view of the assembly of door and transport brackets shown in FIGS. 5-8 wherein the door is depicted having been mounted into the opening and the ability of the transport brackets to provide sufficient clearance to allow the door its full range of motion without interference while being able to be removed therefrom is depicted.

FIG. 10 is a perspective view of an embodiment of the two wheeled door transportation bracket and equipped with brakes, a semi-rigid support structure, and a toggle clamp to provide clamping force.

### DETAILED DESCRIPTION

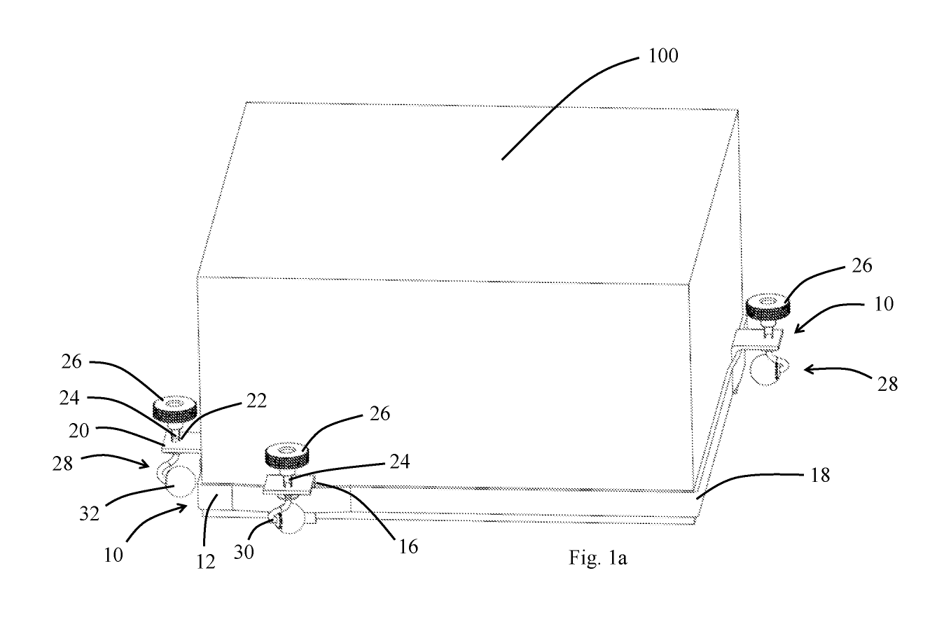

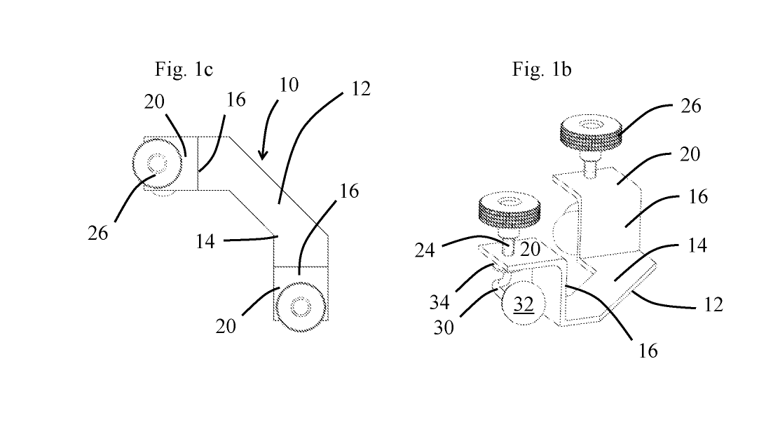

Referring now to FIGS. 1 through 10, embodiments of a transport bracket 10 having one or two adjustable wheel assemblies are depicted.

In FIG. 1a-1c an example of the transportation bracket 10 is shown wherein the support plate 12, having a support surface 14 (not visible in FIG. 1a), and the adjacent vertical beams 16 are arranged and shaped to allow the bracket 10 to receive and support a corner of a box or other object 100 (shown only in FIG. 1a) having three sides meeting at a vertex such as for example a piano, an appliance, a piece of furniture, etc.

As is shown in FIG. 1a, multiple brackets 10 may be used to engage the corners of the object 100. In some embodiments, a binding strap or other securement device 18 may be used to bind multiple brackets 10 together to ensure that they each remain engaged to the object 100 during transport or manipulation.

As indicated above, each transport bracket 10 utilizes a support plate 12 which has two side that extend in a substantially vertical direction upward from the support plate to form vertical beams 16. From each beam is provided a horizontal mounting plate 20 (vertically offset from but parallel with the support plate 12). The mounting plate 20 defines a hole or opening 22 through which a vertical adjustment shaft 24 extends therethrough. In at least one embodiment, the shaft 24 is in threaded engagement with the opening 22 in the manner of a bolt and a nut and is thus vertically adjustable relative there to.

Positioned vertically above the mounting plate 20 and engaged to the top of the vertical adjustment shaft 24 is positioned a handle 26 in the form of a circular grip for manually rotating or otherwise manipulating the shaft 24 (aka: a manual adjustment wheel) so as to allow the shaft 24 to be vertically repositioned relative to the horizontal mounting plate 20. At the bottom of the shaft 24 at a position under or vertically beneath the mounting plate 20 a wheel assembly 28 is engaged to the end of the shaft 24. In at least one embodiment the wheel assembly 28 includes a support shaft or axle 30 about which a caster, roller or other rolling mechanism collectively referred to hereinafter as a wheel 32 is rotatably engaged. In at least one embodiment, the adjustment shaft 24 also includes a rotation collar 34 which allows the wheel assembly 28 to freely rotate about the axis 36 of the adjustment shaft 24 without inadvertently affecting the vertical position of the adjustment shaft 24 relative to the mounting plate 20 as a consequence of the wheel assembly's rotation thereabout.

By rotating the handle 26, the vertical shaft 24 is moved vertically up or down relative to the mounting plate 20. As a consequence, the proximity of the wheel assembly 28 to the mounting plate can be changed (increased or decreased). In other words the wheel assembly 28 can be moved vertically closer to the mounting plate 20 or further away from it by rotating the handle 26 and thus the position of the vertical adjustment shaft 24 relative to the opening 22. By manipulating the vertical position of the wheel 32 in this manner, the relative vertical of the support plate 12 and any object 100 placed on the support surface 14, is thus made vertically adjustable, relative to the wheel 32 and the surface that the wheel 32 is rolling upon (e.g. a floor or ground), constrained only by the length of the vertical adjustment shaft 24.

The handle 26 may be made from plastic, phenolic, metal, rubber or other similar material(s) and have a knurling or other soft grip for ease of operation by hand and may also include an adapter such as a female Allen head receptacle or hex head for operation with for example a portable drill.

The wheel 32 is connected to the vertical adjustment shaft 24 by way of the axle 30, which allows for low friction movement of the bracket 10 across a horizontal surface, even when encumbered by a relatively heavy object 100. Wheel or wheels 32 (for it should be understood that in some embodiments the wheel 32 is in fact multiple wheels rotatably engaged to the axle 30) may be spherical or ball-like castors or rollers, and/or be of a more traditional hub and spoke construction, etc. The wheel 32 may be constructed any suitable material and materials including plastics, polymers or metals. In at least one embodiment the wheel 32 would be non-marring, wear resistant, and slip resistant. The material of the support plate 12, vertical beams 16 and mounting plate 20 may be manufactured from any rigid or semi-rigid material such as aluminum, steel, fiberglass, or plastic.

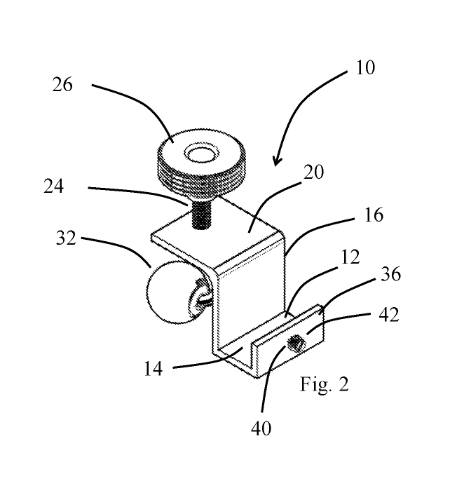

Turning now to the embodiment of the invention shown in FIG. 2, wherein the bracket 10 is configured for the task of supporting and transporting objects 100 such as doors, one or more sheets of lumber, drywall, hard board, composite, countertop material, etc.

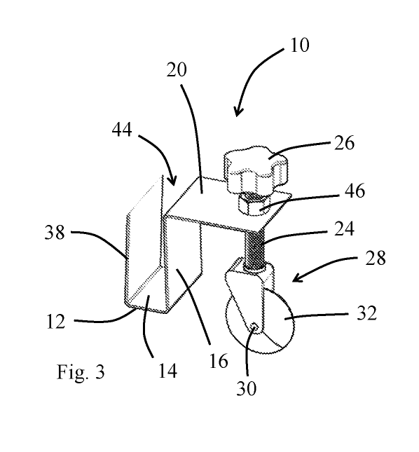

In the embodiment shown in FIG. 2, the bracket 10 is configured to require only a single wheel 32, and thus includes a support plate 12 from which only one vertical beam 16 extends therefrom to terminate in the horizontal mounting plate 20 for support of the vertical adjustment shaft 24 and wheel assembly 28. Positioned opposite of the vertical beam 16 is a retaining lip 38, which while extending vertically from the support plate 12 differs from a vertical beam 16 in that the retaining lip 38 is just that: a lip of sufficient height so as to allow an object such as a door to be positioned between the vertical beam 16 and the lip 38, with sufficient height so as to prevent the door from inadvertently sliding off of the support surface 14 during transport. The height of the retaining lip may be as little as an ⅛ of an inch (3-4 mm) but may be equal to or even greater than the height of the vertical beam 16 such as in the manner shown in FIG. 3

In some embodiments, the retaining lip defines a threaded opening 40 through which a tension member 42 extends therethrough and is adjustably engaged. The tension member 42 is adjusted relative to the retaining lip 38 to apply tension to the object 100 (not shown) positioned upon the support surface 14 and between the vertical beam 16 and the retaining lip 38. In some embodiments the tension member 42 is a threaded bolt, thumbscrew, actuated plunger, or other hand operated device. Optionally, the tension member 42 may comprise a spring or other biasing mechanism for automatic or constant application of tension to the door or other object.

In embodiments where the retaining lip 38 has a length similar to that of the opposing vertical beam 16, such as is the case with the embodiment shown in FIG. 3, the retaining lip 38 may be angled relative to the support plate 12 such that it is inwardly biased toward the opposing vertical beam 16. This provides a narrowing of the channel 44 defined by the lip 38 and beam 16. This narrowing of these opposing structures provides the bracket 10 with a built-in tensioning capability to allow the lip and beam to effectively pinch an object positioned therebetween, and thus be retained by the object in question during transport and manipulation.

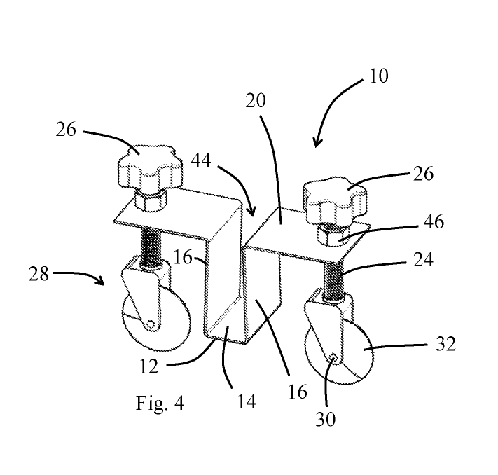

In the embodiment shown in FIG. 4 the bracket 10 is provided with two adjustable wheel assemblies 28, each of which is mounted on opposing sides of the support plate 12 such that the opposing vertical beams 16 and the support plate 12 form a substantially U-shaped channel 44 within their confines. In some embodiments, the vertical beams 16 are each truly vertical in their orientation relative to the support plate 12 (i.e. perpendicular to, or form an angle of 90 degrees with, the support plate 12). In some embodiments, tension with the object being transported e.g. a door, may be provided by forming (or even bending after the fact) one or both of the opposing “vertical” beams 16 to have some play or a slight inward angular orientation/bias in their vertical orientation (thus making them not vertical per se, but rather, oriented such that they defines lines that intersect at some point in space above the support plate 14, e.g. each beam 16 may form an angle of less than 90 degrees with the support plate 12) such that the beams provide an interference fit with the door or similarly sized object positioned therebetween and on the support surface 14.

In some embodiments, the inside surface of one or both of the vertical beams 16 may be provided with an irregular geometry (e.g. bumps, gratings, texturing, etc.), a tacky coating, or other features that will increase the grip or potential frictional interface of the vertical beam(s) 16 with an object placed against it(them).

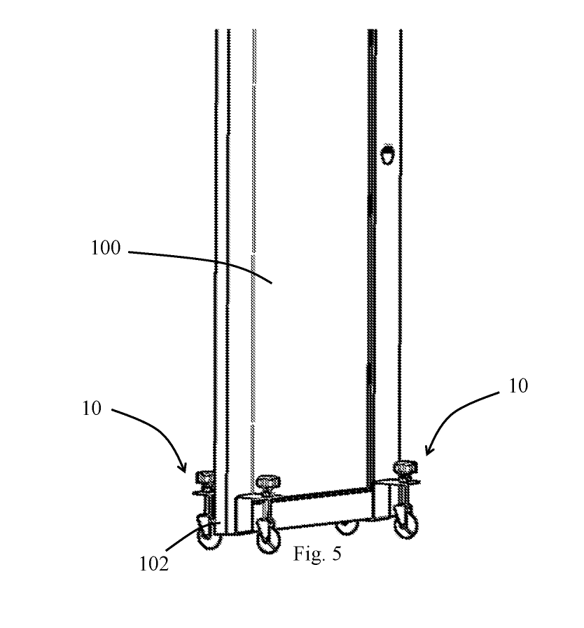

In some embodiments, such as those shown in FIGS. 3 and 4 the vertical adjustment shaft 24 is provided with a retaining nut 46 against the mounting plate 20 and beneath the handle 26. The retaining nut 46 provides the bracket with a locking mechanism (by tightening the nut 46 against the mounting plate 40) to prevent inadvertent adjustment of the wheel assembly 28 relative to the support plate 12 when the bracket is in use and transporting the object. The retaining nut 46 also allows for “fine tuning” such as when leveling a door 100 secured within a pair of brackets 10, such as is shown in FIG. 5.

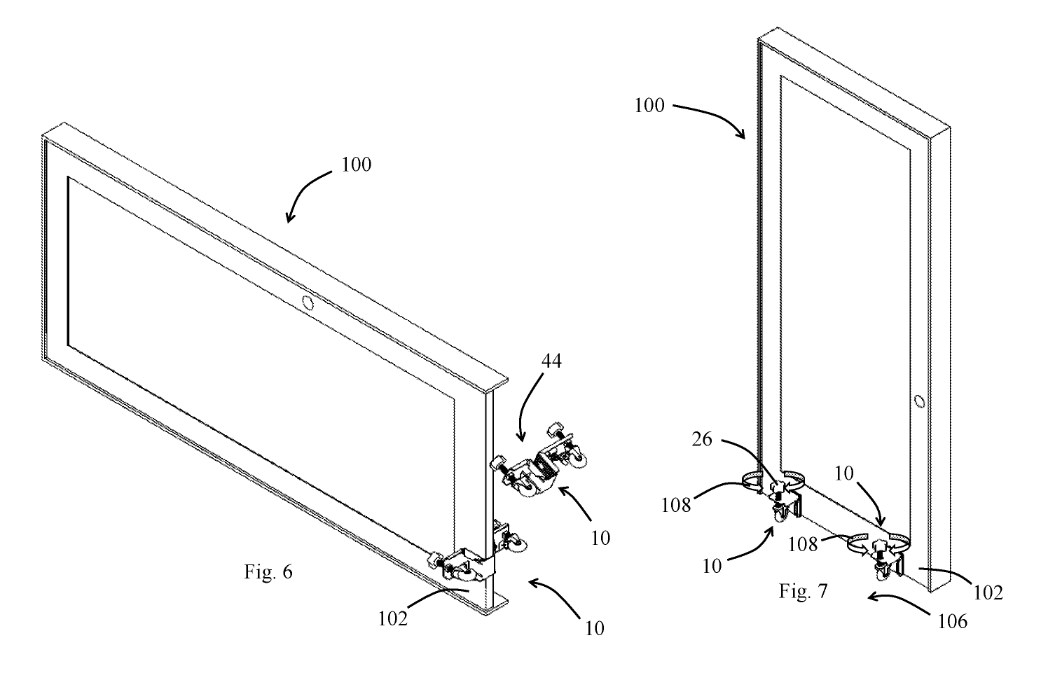

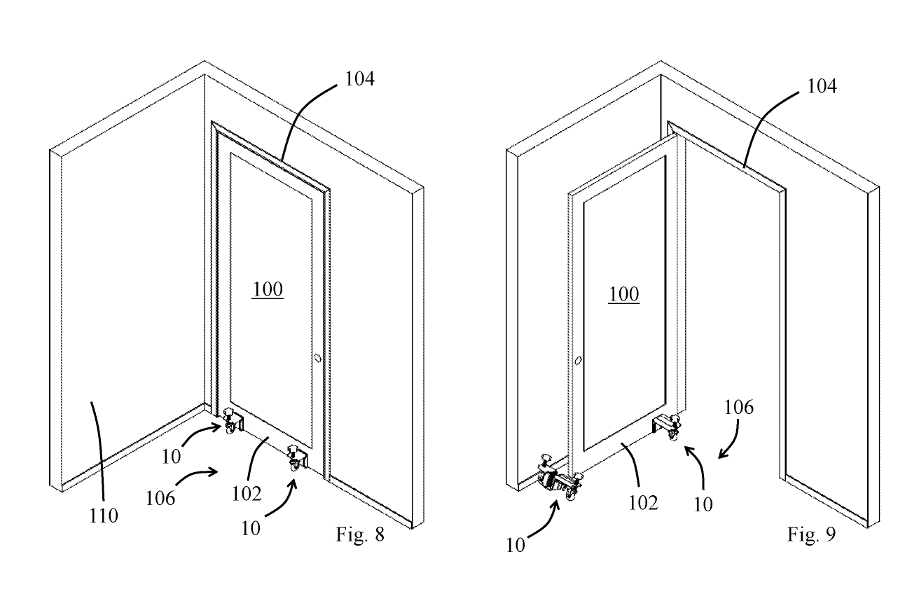

As should be apparent from the above, a primary functional aspect of the transport bracket 10 is to act not only as a mechanism for transporting fairly bulky objects such as doors from one location to another, but to also provide a means for adjusting the position of the object relative to its intended environment of use, such as by adjusting the height of the object carried by the bracket relative to that environment; or in the case of the use of multiple brackets repositioning specific parts of the object relative to others. An example of this functionality is depicted in FIGS. 6-9 wherein a pair of transport brackets 10 are engaged to the base or bottom edge 102 of a door 100 (FIG. 6), then utilized to transport and reposition the door as desired (FIG. 7), position the door 100 into a rough opening 104 (FIG. 8), adjust the height of each bracket 100 as necessary to ensure that the door is level and otherwise aligned properly within the opening, and then once the door is mounted, slide the brackets off of the edge 102 while the door 100 is in its proper mounted position (FIG. 9).

In more detail of the process shown and describe, FIG. 6 shows the door 100 (in this case a pre-hung door with a casing of frame), positioned on its side or oriented such that the bottom edge 102 of the door is readily accessible for securing the brackets 10 thereto. Once the transport brackets 10 are properly secured to the bottom edge or base 102 of the door 100, the door 100, such as is shown in FIG. 7 is placed in its normal vertically upright position, with the wheels 32 of the brackets 10 in contact with the floor or ground 106 in order to roll the door 100 to a desired location and/or place it in a desired orientation.

FIG. 7 also depicts the manner in which the door 100 can be leveled, or its height otherwise adjusted. The two transport brackets 10 can be adjusted separately for height and position when the handle 26 on each transport bracket 10 is rotated in the manner described above and depicted here by arrows 108. The individual height adjustment makes it possible to adjust the door for uneven floors; compensate for differences wherein floors with different heights on each side of the door are present (such as carpeting on one side, hardwood on the other, for example), and allows for leveling the door and matching the rough opening 104 that the door is to be placed within, such as is shown in FIG. 8.

The transport brackets 10 utilize the structure of the door 100 to support the load. Preferably, at least two brackets 10 are utilized to ensure the door 100 has the optimal degree of adjustability and flexibility of movement. The use of brackets 10 in the manner shown is advantageous for the installation of interior and exterior doors as a slab only, or for those doors pre-hung on a frame.

In FIG. 8 it is shown that once the assembly of the door 100 and brackets 10 are in the correct position, and the height(s) of the door 100 are adjusted as needed or desired, the pre-hung door assembly can be installed using several standard methods including with shims, door hinges, etc.

As illustrated in FIG. 9, after installation of the door 100 in this manner, the door 100 can be freely opened and closed with the brackets 10 remaining engaged thereto. The unique shape of the brackets 10 (see for example the description of the substantially U-shaped channel above) provide support to the door 100 before it is hung/mounted but provide the door with enough clearance off of the floor 106 to allow the door to freely swing even while the brackets remain engaged to its base 102. The brackets 10 may be removed from the base of the door 100 by opening the channel defined by the vertical beams 16, releasing the tension member 42, etc. depending on the specific embodiment of the bracket 10

Though illustrated in FIG. 9 via the fact that the door 100 is capable of swinging to a fully open position despite the presence of the brackets 10 engaged thereto (as shown), it should be further emphasized that in some embodiments one side of the bracket 10 is longer than the other. This “shorter side” and “longer side” aspect of the bracket is an inherent feature of the single wheel embodiments of FIGS. 2-3 where there is no second wheel present and thus, the short side 48 of the bracket 10 consists of the retaining lip 38 and tension member 42 (if present), and the longer side 50 consists of the vertical beam 16, mounting plate 20 and wheel assembly 28. Yet, even in the two wheeled embodiment of FIG. 4 one of the mounting plates 20 may extend from its vertical beam 16 on one side of the support plate 12 to a greater length than the mounting plate 20 opposite. This longer mounting plate 20, associated vertical beam 16 and wheel assembly 28 will comprise the “longer side” 50 of this particular type of bracket and the corresponding components opposite will obviously make up the shorter side 48. The shorter side 48 of the bracket 10 intended for orientation toward any wall adjacent to the door 100 when mounted. While both “sides” of a bracket 10 (at least regarding two wheeled embodiments) could be configured such that both are of an equal but similarly “short” length so as to not interfere with the opening of the door 100 relative to an adjacent wall 110, it is desirable to provide at least one side of the bracket 10 with a longer length to provide stability to the bracket 10 particularly when encumbered by a top heavy object such as a door.

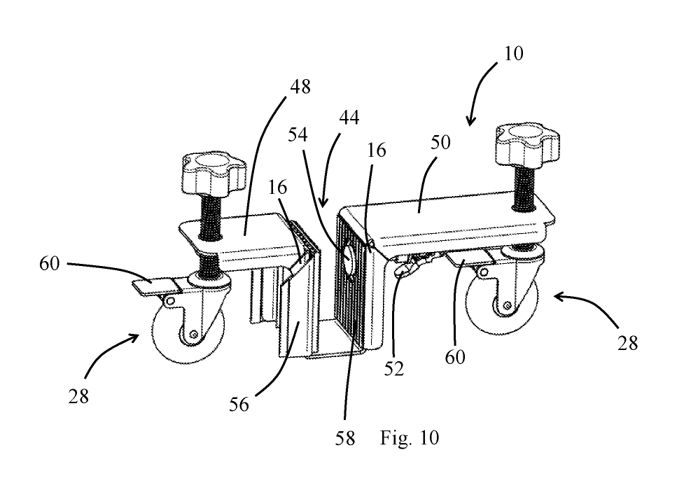

Turning to the embodiment shown in FIG. 10 a version of the two-wheeled bracket 10 is shown, having a variety of features, including the aforementioned shorter and longer sides 48 and 50. The bracket 10 is equipped with a toggle clamp 52 which when actuated applies tension to the object being transported i.e. a door, by applying a biasing force to a toggle foot 54 subsequently holding the door in the door u-shaped channel 44.

On the opposite side of the toggle foot 54 is a spacer clip 56 which can be clipped onto the vertical beam 16 and creates an adjustable clamp of different thickness so as to allow the bracket 10 to accommodate a variety of objects or doors of different thicknesses. In one example, when the spacer clip 56 is installed, the spacing between the clip 56 and foot 54 is sufficient for a door 1.375 inches in thickness; but when the spacer clip 56 is removed, the spacing is increased to accommodate a door of 1.75 inches in thickness. The material of the clip 56 could be any combination of rigid or semi-rigid material such as steel, or plastic with a non-marring surface, preferably with high friction such as rubber.

Inside the channel 44, the inside surfaces of both vertical beams 16 are rubber (or similar material) pads 58 to provide a higher friction surface (“higher” than that of bare, or even painted, metal or plastic of the beams 16 for a comparative example) in accordance with the description above. The pads 58 are adhered to the beams 16 or mechanically engaged there to such as with fasteners or clips.

In addition, the embodiment shown includes wheel assemblies 28 having a braking device 60 to stop movement of the transport bracket 10 and hence the object being transported. The breaking devices may be of any type or configuration but are preferably manually toggled about an axis between a breaking position and a free position, and are independent from one another in operation.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What we claim is:

1. A transport bracket comprising:
a support structure defining a horizontal support surface, at least one beam extending in a substantially vertical direction upward from a side of the support structure, a mounting plate extending horizontally from the at least one beam;
the mounting plate defining an opening;
a vertical adjustment shaft extending through the opening and being threadingly engaged thereto, the vertical adjustment shaft having a top located vertically above the mounting plate and a bottom located vertically below the mounting plate, a handle operatively engaged to the top and a wheel assembly engaged to the bottom, whereby rotation of the handle changes the proximity of the wheel assembly to the mounting plate; and
the wheel assembly comprising an axle extending from the vertical adjustment shaft, and at least one wheel rotatably engaged to the axle.

2. The transport bracket of claim 1 wherein the at least one beam comprises a first beam extending in the substantially vertical direction upward from a first side of the support structure and a second beam extending in the substantially vertical direction upward from a side of the support structure opposite that of the first side.

3. The transport bracket of claim 2, wherein the first beam and the second beam have the same length.

4. The transport bracket of claim 2, wherein the first beam and the second beam have different lengths.

5. The transport bracket of claim 2, wherein at least one of the first beam and the second beam form a 90 degree angle with the support plate.

6. The transport bracket of claim 2, wherein at least one of the first beam and the second beam form an angle of less than 90 degrees with the support plate.

7. The transport bracket of claim 2 wherein the first beam, the second beam and the support surface of the support plate define a substantially U-shaped channel, the substantially U-shaped channel adapted for receipt of an edge of a door.

8. The transport bracket of claim 2 wherein the mounting plate extending horizontally from the first bean has a length equal to that of the mounting plate extending horizontally from the second beam.

9. The transport bracket of claim 2 wherein the mounting plate extending horizontally from the first bean has a length different than that of the mounting plate extending horizontally from the second beam.
